(19) United States
(12) Patent Application Publication
(10) Pub. No.: US 2023/0135586 A1
(43) Pub. Date: May 4, 2023

(54) Gearbox Torque and Speed Calculations from Thermal Sensor Data

(71) Applicant: Dodge Industrial, Inc., Oxford, CT (US)

(72) Inventors: Marius Rutkevicius, Raleigh, NC (US); Stefan Rakuff, Garner, NC (US); Rajib Mikail, Raleigh, NC (US)

(73) Assignee: ABB Schweiz AG, Baden (CH)

(21) Appl. No.: 17/513,583

(22) Filed: Oct. 28, 2021

(51) Int. Cl. F16H 57/02; G06N 20/00; G01M 13/02

(52) U.S. Cl. CPC F16H 57/02; G06N 20/00; G01M 13/02; F16H 2057/02026

(57) ABSTRACT

A system for determining at least one mechanical property of a mechanical power transmitter may use thermal sensor data. The system may include the mechanical power transmitter; at least one thermal sensor disposed on or in the mechanical power transmitter; and a controller configured to receive data from the at least one thermal sensor and to process the data using a model based on machine learning to determine the at least one mechanical property of the mechanical power transmitter.

### BACKGROUND

The field of the disclosure relates to determining mechanical properties of a gearbox or other mechanical power transmitter, and more particularly, to determining mechanical properties of a gearbox using thermal sensor data and a machine learning (ML) model.

A gearbox may be an enclosed system that transmits mechanical power from a power source (input) to an output device through one or more sets of gears. A gearbox may be used to convert such properties as rotational speed (sometimes referred to simply as speed) and torque from the input to the output. One example of a gearbox is a gear reducer. A gear reducer is a mechanical device that reduces the rotational speed and increases the torque generated by an input power source. The ratio between input rotational speed and output rotational speed is accurately reflected in the gear ratio but may not equal the ratio between output torque and input torque because of energy losses (for example, bearing and gear frictional losses, seal drag losses, and oil churning losses) in the gearbox. In some instances, a gearbox may be part of a mechanical power transmission system. For example, the gearbox may change the rotational speed and torque of a prime mover, e.g., an electric motor, a turbine wheel, or an internal combustion engine, and may be located between the prime mover and driven equipment. Driven equipment may include a conveyor, a crusher, a fan, a pump, and the like. A gearbox may achieve its intended effect by having an input gear drive an output gear that has more teeth than the input gear, causing the output gear to rotate more slowly and have higher torque. The gearbox may be operatively coupled to and/or include a gearbox sensor system. The sensor system may include one or more sensors that are capable of obtaining sensor information, such as gearbox mechanical properties of rotational speed, torque, overhung (radial) and thrust (axial) forces applied to the input and output shafts. A gearbox may house just a single pair of gears (single reduction), but often may have two or three stages of gears as well as internal bearings (for example, rolling element bearings of different types) for the rotating shafts.

Gearboxes may be used for many applications and within many different industries such as food processing, mining, oil and gas, and agricultural industries, and the like. Regardless of the application or industry, unplanned downtime due to gearbox failures can be extremely expensive, for example, due to lost production. Catastrophic gearbox failures can occur, for example, due to mechanical defects, such as breaking of the gear teeth or bearing failures. While preventive maintenance and inspections may be performed regularly to reduce the probability of unplanned downtime of the gearbox, these steps incur undesirable labor costs, require maintaining spare parts, and necessitate frequent scheduled downtimes.

Currently, gearbox condition monitoring is often carried out manually by a field engineer or technician who periodically inspects the gearboxes for unusual behavior, perhaps as often as weekly. Further, the gearbox may be in a remote location and/or at an elevated height. This manual monitoring typically includes performing vibration testing and listening for any unusual acoustic patterns coming from a gearbox, checking the oil fill level and oil condition, and checking the temperature of the oil, bearings and other components. Due to the labor costs, it might not be feasible to carry these inspections out regularly especially due to unforeseen circumstances that may arise. Some users of gearboxes might not carry out any inspections at all and then suddenly experience a catastrophic failure and downtime without any warning signal. Accordingly, there remains a technical need to determine the lifetime expectancy of the gearbox to ensure fewer unplanned downtimes. A digital twin could be created for a gearbox, to be used as a virtual gearbox and assist in lifetime expectancy prediction. However, a digital twin requires load inputs, such as torque and speed and thus there is a need to estimate these load inputs from existing configurations in the field.

### SUMMARY

One or more embodiments of the present invention may provide a system for determining at least one mechanical property of a mechanical power transmitter using thermal sensor data. The system may include the mechanical power transmitter; at least one thermal sensor disposed on or in the mechanical power transmitter; and a controller configured to receive data from the at least one thermal sensor and to process the data using a model based on machine learning to determine the at least one mechanical property of the mechanical power transmitter.

One or more embodiments of the present invention may provide a method for determining at least one mechanical property of a mechanical power transmitter using thermal sensor data. The method may include: training a machine learning model to map thermal sensor data from at least one thermal sensor to the at least one mechanical property; acquiring thermal sensor data from at least a subset of the at least one thermal sensor; determining the at least one mechanical property by applying the model to the acquired thermal sensor data, where the at least one thermal sensor is disposed in, on, or in the environment around the mechanical power transmitter.

### BRIEF DESCRIPTION OF THE DRAWINGS

FIGS. 1A and 1B show temperature profiles of a gearbox in operation using an infrared camera in accordance with one or more embodiments.

FIGS. 2A and 2B show gearbox thermocouple locations in accordance with one or more embodiments.

FIG. 2C shows a cutaway view of an exemplary gearbox in accordance with one or more embodiments.

FIG. 3 shows a relationship between temperature and torque in accordance with one or more embodiments.

FIG. 4 shows a relationship between temperature and rotational speed in accordance with one or more embodiments.

FIG. 5 shows a flowchart in accordance with one or more embodiments.

### DETAILED DESCRIPTION

One or more embodiments of the present invention may be used for quantifying transmitted torque loads or transmitted rotational speed of industrial gearboxes without the use of expensive torque sensors, position sensors, or vibration sensors. In one or more embodiments, temperature measurements from low-cost temperature sensor data may be used to provide transmitted torque load or transmitted rotational speed. Torque and rotational speed calculated by methods described herein may be used in measurement of gearbox component lifetimes, as well as generating component usage datasets. Further, the systems and methods described herein may be applied to other mechanical power transmitters such as mounted bearings, a bearing race, a pulley, a chain or belt drive, sheaves, and the like.

Advanced digital solutions may rely on sensor data from the field to model digital products for Internet of Things (IOT) or Industry 4.0 solutions, simplifying user maintenance efforts. Sensor packages may combine more than one sensor in a mountable package. For example, a sensor package may include a vibration sensor (e.g., an accelerometer) and a thermal sensor. Thermal sensors include thermocouples, resistance temperature detectors (RTDs), thermometers, infrared sensors and cameras, silicon diodes, and thermistors. A mountable package may be fixed by screw, adhesive, clamping, or other suitable means. Sensor data may be provided to a digital copy of a physical device or system from systems such as ones for mounted bearings. A digital copy developed for a gearbox (see “Digital Twin” mentioned above) may also require the mechanical gearbox loads such as applied torques and rotational speeds, quantities that may not be directly measured by a sensor package for mounted bearings that measures vibrations and temperature. Installing additional torque and rotational speed sensors to measure the gearbox operating condition may be too expensive and complicated for most users. One or more embodiments of the present invention may utilize measurements of gearbox temperature distribution to find transmitted torque and/or transmitted rotational speed and/or overhung shaft forces, that is, the output torque and output rotational speed.

One or more embodiments of the present invention may make use of a temperature-torque relationship in gearboxes to predict torque level from temperature. For instance, in one or more embodiments, the temperature-torque relationship may be approximately linear. Estimating torque in this manner may be performed with an inexpensive, easy-to-install, common temperature, or thermal, sensor.

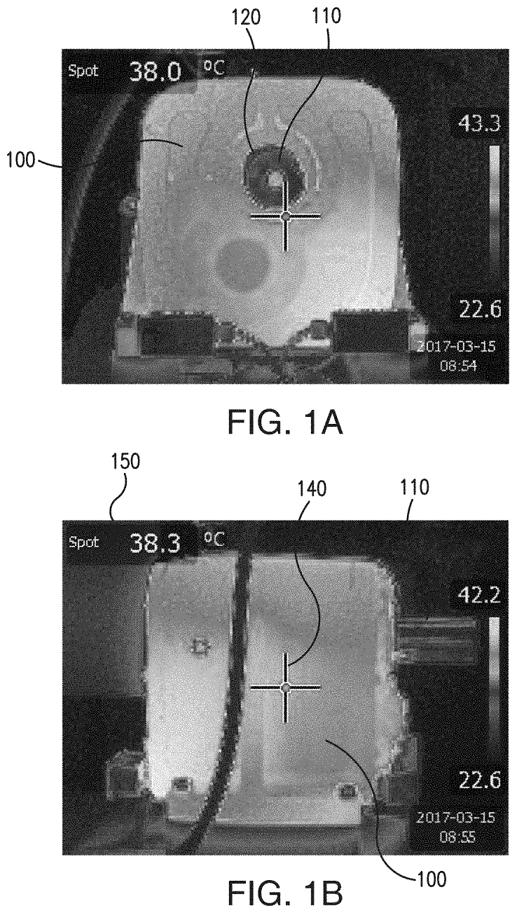

The thermal sensor could be one of the types of thermal sensors mentioned above. For example, the thermal sensor may be an infrared camera. FIGS. 1A and 1B show infrared images, that is, temperature profiles, of a gearbox in operation. FIG. 1A provides a front view of the gearbox housing 100 and an output shaft 110 passing through an output shaft opening 120 in the housing 100. FIG. 1B provides a side view of the housing 100 and output shaft 110. A temperature scale is provided on the right side of both figures. A temperature is provided for each pixel in the infrared images. A cross-hairs 140 identifies a spot for which a temperature is displayed in digital form 150. The higher temperatures observed at the bottom of the gearbox in FIGS. 1A and 1B may be due to the presence of oil, which lubricates the gearbox and is heated through oil churning. That is, the bottom portion of the gearbox may be below the oil level. A thermal sensor may be mounted to measure temperature of a specific bearing surface in a gearbox or could be used to measure temperature of the gearbox housing.

In one or more embodiments, a data acquisition system may be used to read the sensor signals (temperature sensors) from the gearbox. This sensor data transfer may be wired or wireless. A data acquisition system for one embodiment may include a National Instruments Compact DAQ chassis with a compatible thermocouple or RTD module. National Instruments LabView may be used to control the data acquisition system.

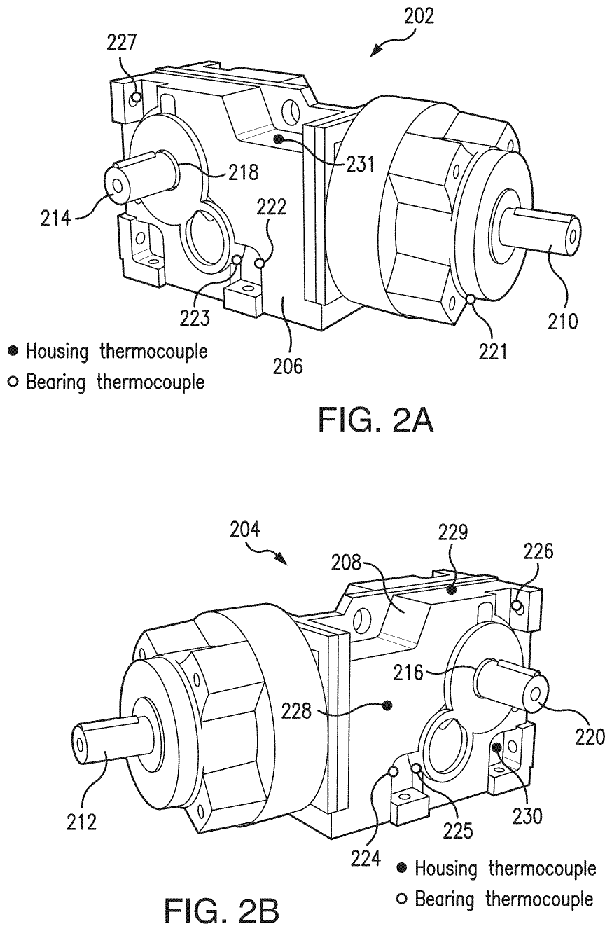

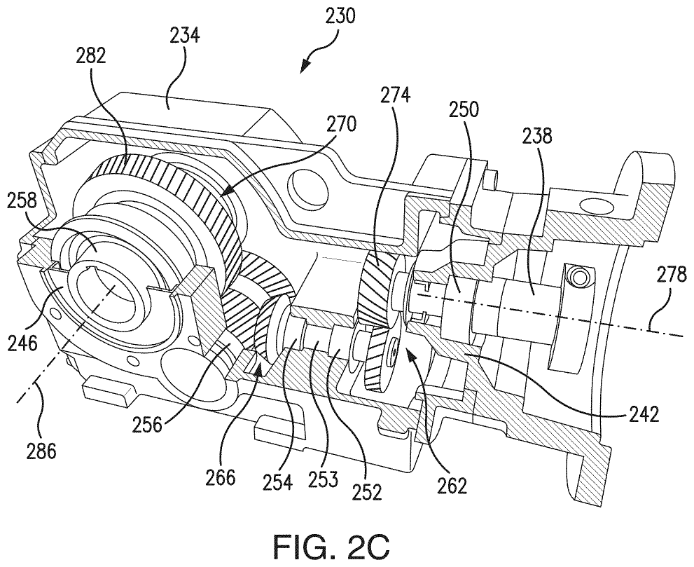

Systems and methods described herein may apply to many types of industrial gearboxes and other mechanical power transmitters. In one embodiment of the invention, the gearbox is a Dodge Quantis RHB gearbox, though many other industrial gearboxes could be used. For the present example, there are eleven measurement locations including bearing raceway and gearbox housing as shown in FIGS. 2A and 2B.

FIGS. 2A and 2B show exemplary gearboxes 202, 204 for which temperature information (i.e., thermal sensor data) may be acquired from thermal sensors (e.g., thermocouples). Each gearbox 202, 204 may include a housing 206, 208, an input shaft 210, 212 passing through an input shaft opening in the housing, and an output shaft 214, 216 passing through an output shaft opening 218, 220 in the housing. As shown these figures, a bearing thermocouple may be placed at locations 221, 222, 223, 224, 225, 226, and 227 by drilling a hole in the gearbox housing, while a housing thermocouple may be mounted on the gearbox housing at locations 228, 229, 230, and 231. However, measurements from a single location has been sufficient for one or more embodiments. Further, data from an infrared camera may be used.

FIG. 2C shows a similar exemplary gearbox 230 with a housing 234. An input shaft 238 may pass through an input shaft opening 242 in the housing 234, while an output shaft may pass through an output shaft opening 246. Bearing raceways 250, 252, 254, 256, 258 containing bearings may provide low-resistance support for gearbox shafts, including internal shafts 253. In the gearbox 230 shown in FIG. 2C, three stages are seen: stage one 262, stage two 266, and stage three 270. An input gear 274 may be configured to rotate synchronously with the input shaft 238 around an input shaft axis 278. Similarly, an output gear 282 may be configured to rotate synchronously with the output shaft around an output shaft axis 286. The output gear 282 may be operatively coupled to the input gear 274.

Several phenomena that generates heat in a gearbox during operation can be identified, such as friction, oil churning, and seal drag losses.

It is well known that heat generated is a function of the speed of the system, contact pressure, and friction. It may thus be possible to calculate pressure knowing the other three parameters (velocity, heat, and friction). Similarly, it may be possible to calculate velocity with known pressure, heat and friction. For a non-insulated gearbox, the heat may be constantly dissipated (transferred) to surrounding environment via conduction or convection. Thus, at constant speed and constant torque, a steady state condition may be achieved where heat dissipated is equal to heat generated. At steady state, the temperature of the gearbox components may have negligible variation for a given time duration. In industrial use, gearboxes may operate for extended periods of time. For example, a gearbox may operate continuously through an 8-hour shift, 24 hours per day in a food factory, months at a time on an oil rig, or 3 months per year in an agriculture setting, such as processing grains.

Gearbox temperature in steady state was measured by thermocouples placed at 11 locations on each of the gearboxes (locations 221-231 of FIGS. 2A and 2B) and additionally oil temperature was measured. Temperature data from different locations on the gearbox may be correlated to the torque of the gearbox.

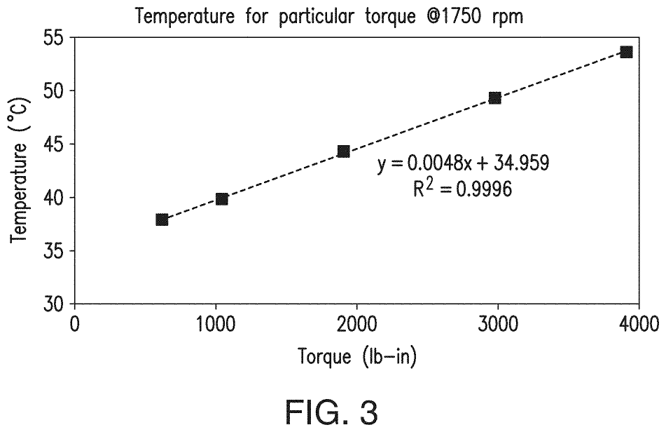

From regression analysis, as shown in FIG. 3, a line corresponding to the linear regression may be drawn across five temperature values measured at five different torque values for thermocouple 3. An R-squared value of 0.9996 was achieved. The relationship for equilibrium temperature and torque at 1750 revolutions per minute (rpm) shows a linear equation of the type y=ax+c, where, y is the temperature, x is the torque, and a, c are constants. Rearranging the equation can yield torque:

torque=(temperature−c)/a.

The prediction of torque from the above equation is demonstrated in Table 1. Predicted torque was within 9% of the measured value. The temperature input values were not normalized to room temperature, as a laboratory temperature fluctuation of only 3 degrees Celsius (° C.) was recorded, but ambient temperature corrections may be needed if the fluctuations are higher and are discussed below. Table 1 also contains calculated torque from a linear regression model of temperature-torque graphs and the difference from measured and calculated torque in percent. The measured torques of Table 1 were used to create a temperature-torque relationship (or map), while the predicted torques were generated using temperature sensor data and the temperature torque relationship.

TABLE 1
Measured torque values used to create temperature -
torque relationship of sensor #223.

| Torque, | Torque, | Difference | |
|---|---|---|---|
| calculated | measured | in torque | |
| [lb-in (Nm)] | [lb-in (Nm)] | estimation | Type |
| 3888 (439) | 3931 (444) | 1% | Training |
| 2985 (337) | 2980 (337) | 0% | Training |
| 1015 (115) | 1050 (119) | 3% | Training |
| 1949 (220) | 1985 (224) | 2% | Training |
| 674 (76) | 620 (70) | 9% | Prediction |
| 4032 (456) | 3896 (440) | 3% | Prediction |

Typically, stable temperature may be achieved between 3 and 5 hours after the initiation of testing, where a stable temperature may be defined as a change in temperature of less than 1° C./hour. This method assumes a known shaft speed and a known gearbox configuration.

Correlation of the temperature recorded by a specific thermocouple at steady temperature to torque is shown in Table 2. A higher R-squared value shows that the torque prediction is more accurate. (R-squared=1 indicates perfect prediction, R-squared=0 indicates very poor prediction, R-squared=−1 would indicate completely perfect but negative prediction). The R-squared values in Table 2 show very good prediction possibility from any of the thermocouple locations.

TABLE 2
Thermocouple sensor data correlation (R²) to gearbox output
torque. Data is arranged from highest to lowest R².

| Sensor ID | R-squared |
|---|---|
| 223 | 0.99957 |
| 225 | 0.99871 |
| 222 | 0.99831 |
| 224 | 0.99822 |
| 228 | 0.99701 |
| 227 | 0.99617 |
| 230 | 0.99610 |
| 231 | 0.99591 |
| 226 | 0.99366 |
| 229 | 0.99306 |
| 221 | 0.98328 |

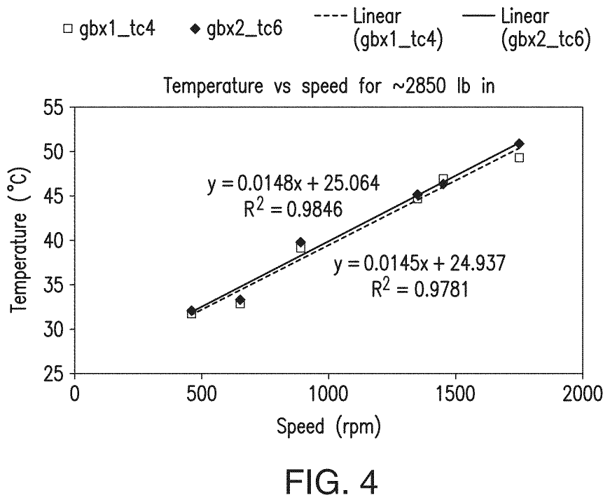

In one or more embodiments, the rotational speed of the gearbox may be predicted. Since temperature is proportional both to speed and load, with a known torque the embodiments may be used to predict rotational speed from temperature data. Linear regression equations for rotational speed prediction from the temperature data (that is, thermal sensor data) may be created by measuring several (at least two) temperature points at two different rotational speed settings, similar to ones shown in FIG. 4. The R-squared values for rotational speed prediction are slightly lower at 0.97-0.98, allowing to calculate rotational speed to within approximately 12% accuracy, shown in Table 3. For these embodiments, to carry out the rotational speed estimation, one must a) know the torque load, or perform the estimation only in conditions where torque loads are constant, and b) have constant operating speed until a steady temperature condition is reached.

TABLE 3
Speed prediction from temperature data of thermocouple #224.
Values include training to construct linear regression
and prediction, following linear regression equation.

| | Torque | Difference | Speed | Speed |
|---|---|---|---|---|
| | reading | in speed | calculated | measured |
| Type | [lb-in (Nm)] | estimation | [rpm] | [rpm] |
| Training | 2980 (337) | −5% | 1658 | 1750 |
| Training | 2865 (324) | 0% | 1344 | 1349 |
| Training | 2871 (324) | 9% | 965 | 889 |
| Training | 2865 (324) | 0% | 460 | 460 |
| Training | 2863 (324) | 3% | 1496 | 1449 |
| Prediction | 2830 (320) | −12% | 397 | 449 |
| Prediction | 2831 (320) | −8% | 415 | 449 |
| Prediction | 2826 (319) | −3% | 1110 | 1149 |
| Prediction | 2829 (320) | −2% | 1131 | 1149 |
| Prediction | 2819 (318) | −1% | 1731 | 1749 |

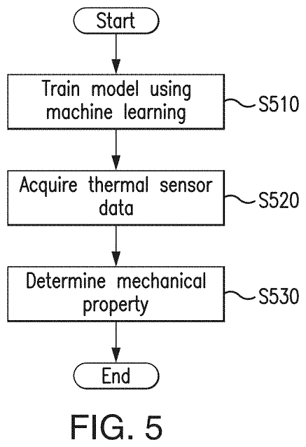

One or more embodiments of the present invention may provide a method for determining at least one mechanical property of a mechanical power transmitter, for example, a gearbox, using thermal (i.e., temperature) sensor data. Referring to FIG. 5, the method may include training (or fitting) a machine learning model to map thermal sensor data from at least one thermal sensor to at least one mechanical property S510. The machine learning model may be a linear or non-linear regressor. The training may use stochastic gradient decent (SGD). The dimensionality of the data may be reduced using principal component analysis. The data may be scaled using a min-max or standard scaler. Mechanical properties that may be mapped to thermal sensor data may include input shaft torque, output shaft torque, input shaft rotational speed, output shaft rotational speed, and the like. The thermal sensors may be located in, on, or in the environment around the mechanical power transmitter. Thermal sensors in the environment around the mechanical power transmitter may allow for the effect of changes in ambient temperature on the model. For example, a gearbox may be exposed to different amounts of sunlight during a 24-hour period of operation, or seasonal temperature changes.

The method may also include acquiring thermal sensor data from at least a subset of the thermal sensors used in training the model S520. The mapped thermal sensor data and the acquired thermal sensor data may be acquired during steady state operation of the mechanical power transmitter.

The method may include determining at least one mechanical property by applying the model to the acquired thermal sensor data S530. For example, using thermal sensor data from one or more thermal sensors, a mechanical property like output shaft torque or output shaft rotational speed may be determined. With the use of two or more thermal sensors, more than one mechanical property may be determined. For example, using thermal sensor data from two or more thermal sensors may allow both output shaft torque and output shaft rotational speed to be determined. In this case, the machine learning model would be trained using temperature data collected for these different output shaft torques and rotational speeds. The machine learning model may be a multiple-output linear regressor.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for determining at least one mechanical property of a mechanical power transmitter using thermal sensor data, the system comprising:
the mechanical power transmitter;
at least one thermal sensor disposed on or in the mechanical power transmitter; and
a controller configured to receive data from the at least one thermal sensor and to process the data using a model based on machine learning to determine the at least one mechanical property of the mechanical power transmitter.

2. The system of claim 1, wherein the received data was acquired during steady state operation of the mechanical power transmitter.

3. The system of claim 1, wherein the mechanical power transmitter comprises at least one member of a group consisting of a plurality of bearings, a bearing race, a pulley, a chain drive, a belt drive, a gearbox, and sheaves.

4. The system of claim 3, wherein the at least one thermal sensor comprises a member of a group consisting of a thermocouple, a resistance temperature detector, an infrared sensor, an infrared camera, a silicon diode, and a thermistor.

5. The system of claim 4, wherein the mechanical power transmitter comprises the gearbox, the gearbox comprising:
a housing comprising:
an input shaft opening; and
an output shaft opening;
an input shaft configured to rotate about an input shaft axis and passing through the input shaft opening;
an output shaft configured to rotate about an output shaft axis, passing through the input shaft opening, and operatively coupled to the input shaft;
an input gear configured to rotate synchronously with the input shaft about the input shaft axis;
an output gear configured to rotate synchronously with the output shaft about the output shaft axis and operatively coupled to the input gear;
at least one set of bearings disposed in a corresponding pair of bearing races and around the input shaft; and
at least one set of bearings disposed in a corresponding pair bearing races and around the input shaft.

6. The system of claim 5, wherein at least one mechanical property comprises at least one member of a group consisting of input shaft torque, output shaft torque, input shaft rotational speed, output shaft rotational speed.

7. The system of claim 6, wherein:
the at least one thermal sensor comprises a plurality of thermal sensors, and
the controller predicts the at least one mechanical property using data from at least two the thermal sensors.

8. The system of claim 7, wherein:
the at least one predicted mechanical property comprises a plurality of predicted mechanical properties, and
a quantity of the thermal sensors is greater than or equal to a quantity of the predicted mechanical properties.

9. The system of claim 8, wherein locations of the plurality of thermal sensors are members of a group consisting of an outside surface of the housing, an inside surface of the housing, on or adjacent to a bearing race around the input shaft, the output shaft, or an internal shaft, below an oil level in the housing, above the oil level in the housing, and in a location with an ambient temperature.

10. A method for determining at least one mechanical property of a mechanical power transmitter using thermal sensor data, the method comprising:
training a machine learning model to map thermal sensor data from at least one thermal sensor to the at least one mechanical property;
acquiring thermal sensor data from at least a subset of the at least one thermal sensor;
determining the at least one mechanical property by applying the model to the acquired thermal sensor data,
wherein the at least one thermal sensor is disposed in, on, or in the environment around the mechanical power transmitter.

11. The method of claim 10, wherein the mapped thermal sensor data and the acquired thermal sensor data were acquired during steady state operation of the mechanical power transmitter.

12. The method of claim 10, wherein the machine learning model comprises a member of a group consisting of linear regression and non-linear regression.

13. The method of claim 12, wherein at least one mechanical property comprises at least one member of a group consisting of input shaft torque, output shaft torque, input shaft rotational speed, output shaft rotational speed.

14. The method of claim 13, wherein the mechanical power transmitter comprises at least one member of a group consisting of a plurality of bearings, a bearing race, a pulley, a chain or belt drive, a gearbox, and sheaves.

15. The method of claim 14, wherein the mechanical power transmitter comprises a gearbox, the gearbox comprising:
a housing comprising:
an input shaft opening; and
an output shaft opening;
an input shaft configured to rotate about an input shaft axis and passing through the input shaft opening;
an output shaft configured to rotate about an output shaft axis, passing through the input shaft opening, and operatively coupled to the input shaft;
an input gear configured to rotate synchronously with the input shaft about the input shaft axis;
an output gear configured to rotate synchronously with the output shaft about the output shaft axis and operatively coupled to the input gear;
at least one set of bearings disposed in a corresponding pair of bearing races and around the input shaft; and
at least one set of bearings disposed in a corresponding pair bearing races and around the input shaft.

16. The method of claim 15, wherein the at least one mechanical property comprises input shaft torque, output shaft torque, input shaft rotational speed, output shaft rotational speed.

17. The method of claim 16, wherein:
the at least a subset of the at least one thermal sensor comprises a plurality of thermal sensors, and
the at least a subset of the at least one thermal sensor comprises at least two the thermal sensors.

18. The method of claim 17, wherein:
the at least one determined mechanical property comprises a plurality of determined mechanical properties, and
a quantity of the at least two thermal sensors is greater than or equal to a quantity of the determined mechanical properties.

19. The method of claim 18, wherein the plurality of determined mechanical properties comprise the output shaft torque and the output shaft rotational speed.
